(19) United States
(12) Patent Application Publication
(10) Pub. No.: US 2011/0244329 A1
(43) Pub. Date: Oct. 6, 2011

(54) CATHODE ACTIVE MATERIAL FOR LITHIUM SECONDARY BATTERY AND LITHIUM SECONDARY BATTERY HAVING THE SAME

(75) Inventors: Yoon Han Chang, Hwaseong-si (KR); Sang-Hoon Jeon, Daegu (KR); Chang-Won Park, Suwon-si (KR)

(73) Assignee: L F Material Co., Ltd., Chilgok-gun (KR)

(21) Appl. No.: 12/933,387

(22) PCT Filed: Mar. 20, 2009
(86) PCT No.: PCT/KR09/01444

§ 371 Date: Oct. 22, 2010

(30) Foreign Application Priority Data
Mar. 20, 2008 (KR) 10-2008-0025689

(51) Int. Cl. H01M 4/54; H01M 4/48; H01M 4/52; H01M 4/50; B82Y 30/00

(52) U.S. Cl. 429/219; 429/220; 429/221; 429/222; 429/223; 429/224; 252/182.1; 977/773

(57) ABSTRACT

Provided are a cathode active material for a lithium secondary battery and a lithium secondary battery including the same. The cathode active material includes a lithium composite oxide represented by the following Chemical Formula 1.

Li[Li_{z}A]O₂

A={M¹_{1-x-y}(M¹_{0.78}Mn_{0.22})ₓ}M²_{y} [Chemical Formula 1]

In Chemical Formula, M¹ and M² are independently one or more selected from a transition element, a rare earth element, or a combination thereof, M¹ and M² are elements that are different from each other, −0.05≦z≦0.1, 0.8≦x+y≦1.8, and 0.05≦y≦0.35, and Ni has an oxidation number of 2.01 to 2.4.

### FIELD OF THE INVENTION

The present invention relates to a cathode active material for lithium secondary battery and lithium secondary battery having the same, and more particularly, the present invention relates to a cathode active material for lithium secondary battery and lithium secondary battery having the same.

### DESCRIPTION OF THE RELATED ART

In recent times, due to reductions in size and weight of portable electronic equipment, there has been a need to develop batteries for the portable electronic equipment that have both high performance and large capacity.

Batteries generate electrical power using an electrochemical reaction material for a cathode and an anode. The exemplary of these batteries are lithium secondary batteries that generate electrical energy due to chemical potential changes during intercalation/deintercalation of lithium ions at cathode and anode.

The lithium secondary batteries include a material that reversibly intercalates and deintercalates lithium ions during charge and discharge reactions as both cathode and anode active materials, and is prepared by are filling with an organic electrolyte or a polymer electrolyte between the cathode and anode.

For the cathode active material for a lithium secondary battery, lithium metal oxide compound are generally used, and metal oxide composites such as LiCoO₂, LiMn₂O₄, LiNiO₂, LiNi₁₋ₓCoₓO₂ (0<x<1), LiMnO₂, and so on have been researched.

Among the cathode active materials, a manganese-based cathode active material such as LiMn₂O₄ and LiMnO₂ is easy to synthesize, costs less than other materials, has excellent thermal stability compared to other active materials, and is environmentally friendly, but this manganese-based material has relatively low capacity.

LiCoO₂ has good electrical conductivity, a high cell voltage of about 3.7V, and excellent cycle life, stability, and discharge capacity, and thus is a presently-commercialized representative material. However, LiCoO₂ is so expensive that it makes up more than 30% of the cost of a battery and thus may lose price competitiveness.

In addition, LiNiO₂ has the highest discharge capacity among the above cathode active materials, but is hard to synthesize. Furthermore, nickel therein is highly oxidized and may deteriorate the cycle life of a battery and an electrode and thus may cause severe deterioration of self discharge and reversibility. Further, it may be difficult to commercialize due to incomplete stability.

### DETAILED DESCRIPTION OF THE INVENTION

### Summary of the Invention

An exemplary embodiment of the present invention provides a cathode active material for a lithium secondary battery, which has excellent thermal stability and a low cost.

Another embodiment of the present invention provides a lithium secondary battery including the cathode active material.

The embodiments of the present invention are not limited to the above technical purposes, and a person of ordinary skill in the art can understand other technical purposes.

### Technical Solution

A first embodiment of the present invention provides a cathode active material for a lithium secondary battery including a lithium oxide composite represented by the following Chemical Formula 1.

Li[Li_{z}A]O₂

A={M¹_{1-x-y}(M¹_{0.78}Mn_{0.22})ₓ}M²_{y} [Chemical Formula 1]

(wherein, M¹ and M² are independently one or more selected from a transition element, a rare earth element, or a combination thereof, M1 and M2 are elements that are different from each other, −0.05≦z≦0.1, 0.8≦x+y≦1.8, 0.05≦y≦0.35, and Ni has an oxidation number of 2.01 to 2.4.)

A second embodiment of the present invention provides a lithium secondary battery including the cathode active material.

### Advantageous Effect

The present invention may provide a cathode active material with excellent thermal stability by controlling the oxidation number of an element included therein.

### BRIEF DESCRIPTION OF THE DRAWINGS

FIG. 1 shows balance chart of manganese, cobalt, and nickel compositions in a cathode active material with a layered structure according to Examples 1 to 9 of the present invention and Comparative Examples 1 and 2.

FIG. 2 is a graph showing thermal stability characteristics (DSC) of the cathode active materials according to Examples 1 to 9 of the present invention and Comparative Examples 1 and 2.

FIGS. 3 and 4 are scanning microscope photographs showing the surface of particles including the cathode active material of Comparative Example 1.

FIGS. 5 and 6 are scanning microscope photographs showing the surface of particles including the cathode active material of Comparative Example 2 of the present invention.

FIGS. 7 and 8 are scanning microscope photographs showing the surface of particles including the cathode active material of Example 1 of the present invention.

FIGS. 9 and 10 are scanning microscope photographs showing the surface of particles including the cathode active material of Example 2 of the present invention.

FIGS. 11 and 12 are scanning microscope photographs showing the surface of particles including the cathode active material of Example 3 of the present invention.

FIGS. 13 and 14 are scanning microscope photographs showing the surface of particles including the cathode active material of Example 4 of the present invention.

FIGS. 15 and 16 are scanning microscope photographs showing the surface of particles including the cathode active material of Example 5 of the present invention.

FIGS. 17 and 18 are scanning microscope photographs showing the surface of particles including the cathode active material of Example 6 of the present invention.

FIGS. 19 and 20 are scanning microscope photographs showing the surface of particles including the cathode active material of Example 7 of the present invention.

FIGS. 21 and 22 are scanning microscope photographs showing the surface of particles including the cathode active material of Example 8 of the present invention.

FIGS. 23 and 24 are scanning microscope photographs showing the surface of particles including the cathode active material of Example 9 of the present invention.

### BEST MODE FOR WORKING INVENTION

Exemplary embodiments of the present invention will hereinafter be described in detail. However, these embodiments are only exemplary, and the present invention is not limited thereto.

A positive active material according to a first embodiment of the present invention, includes a lithium composite oxide represented by the following Chemical Formula 1.

Li[Li_{z}A]O₂

A={M¹_{1-x-y}(M¹_{0.78}Mn_{0.22})ₓ}M²_{y} [Chemical Formula 1]

wherein, M¹ and M² are one or more transition elements that are different from each other.

M¹ is preferably selected from the group consisting of Ni, Co, Ti, Mg, Cu, Zn, Fe, Al, La, Ce, and a combination thereof, and is more preferably Ni. Furthermore, M² is preferably selected from the group consisting of Ni, Co, Ti, Mg, Cu, Zn, Fe, Al, La, Ce, and a combination thereof, and is more preferably Co.

The z, x, and y are preferably defined as −0.05≦z≦0.1, 0.8≦x+y≦1.8, and 0.05≦y≦0.35, and more preferably −0.03≦z≦0.09, 1.0≦x+y≦1.8, and 0.05≦y≦0.35.

In a compound represented by the above Chemical Formula 1, Ni preferably has an oxidation number ranging from 2.01 to 2.4. When Ni has an oxidation number of less than 2.01 or more than 2.4, a compound may have a large initial cycle irreversible capacity or deteriorated thermal stability. In addition, when Ni has an oxidation number of less than 2.01 or more than 2.4, the cathode active material may have a problem of long cycle life characteristic degradation.

A lithium composite oxide as a cathode active material may be a secondary particle assembled by primary particles, and preferably has better stability and electrochemical characteristics than one formed as a huge particle.

In addition, the secondary particle may be spherical. The secondary particle has a size with D₅₀ ranging from 5 μm to 12.2 μm, D₅ ranging from 2.5 μm to 6.5 μm, and D₉₅ ranging from 9 μm to 20 μm. In this specification, the particle size D₅ is one when an active material particle with various particle size distributions of 0.1, 0.2, 0.3, . . . , 3, 5, 7, . . . , 10, 20, and 30 μm is accumulated at up to 5% of a weight ratio, D50 indicates a particle size when an active material particle is accumulated at up to 50% of a weight ratio, and D95 indicates a particle size when an active material particle is accumulated at up to 95% of a weight ratio.

Herein, the primary particle may have an average particle long diameter ranging from 50 nm to 2.5 μm, or from 200 nm to 2.3 μm in another embodiment. In addition, the primary particle may have an average particle long diameter ranging from 0.5 μm to 2.3 μm.

When the primary particle has an average particle long diameter within the range, it may be good for forming a secondary particle and securing appropriate tap density, and accomplishing excellent stability and capacity characteristics.

Accordingly, the cathode active material of the present invention with the above composition has excellent thermal stability.

According to another embodiment of the present invention, the cathode active material may be prepared in a co-precipitation method, and for example, a transition metal oxide composite among starting materials used for preparing a cathode active material may be prepared by a method disclosed in Japanese Patent Laid-Open Publication No. 2002-201028.

The cathode active material of the present invention may be usefully applied to a cathode for a lithium secondary battery. The lithium secondary battery may include an anode including an anode active material, and an electrolyte and a cathode.

The cathode is fabricated by mixing a cathode active material of the present invention, a conductive material, a binder, and a solvent to prepare a cathode active material composition, then directly coating the cathode active material composition on an aluminum current collector and drying it. Alternatively, the cathode active material composition is coated on a separate support and then peeled off from the supporter, followed by laminating the film on an aluminum current collector.

The conductive material may include carbon black, graphite, and a metal powder, and the binder may include a vinylidene fluoride/hexafluoropropylene copolymer, polyvinylidene fluoride, polyacrylonitrile, polymethylmethacrylate, polytetrafluoroethylene, and mixtures thereof. Furthermore, the solvent includes N-methylpyrrolidone, acetone, tetrahydrofuran, decane, and the like. Herein, the amounts of the cathode active material, the conductive material, the binder, and the solvent are the same as commonly used in a lithium secondary battery.

Like the cathode, the anode is fabricated by preparing an anode active material composition by mixing an anode active material, a binder, and a solvent, coating the composition on a copper current collector or coating it on a separate supporter, peeling it, and then laminating the film on a copper current collector. Herein, the anode active material composition may further include a conductive material, if necessary.

The anode active material may include a material that intercalates/deintercalates lithium, for example, lithium metal or a lithium alloy, coke, artificial graphite, natural graphite, an organic polymer compound combustion material, carbon fiber, and the like. In addition, the conductive material, binder, and solvent may be the same as aforementioned.

The separator materials include polyethylene, polypropylene, and polyvinylidene fluoride, or a multi-layer thereof which is double or more-layer, and it is generally used in a lithium secondary battery, and for example is a polyethylene/polypropylene double-layered separator, a polyethylene/polypropylene/polyethylene triple-layered separator, or a polypropylene/polyethylene/polypropylene triple-layered separator.

The electrolyte charged for a lithium secondary battery may include a non-aqueous electrolyte, a solid electrolyte, or the like, in which a lithium salt is dissolved.

The solvent for a non-aqueous electrolyte includes, but is not limited to, cyclic carbonates such as ethylene carbonate, propylene carbonate, butylene carbonate, vinylene carbonate, and the like, linear carbonates such as dimethyl carbonate, methylethyl carbonate, diethylcarbonate, and the like; esters such as methyl acetate, ethyl acetate, propyl acetate, methyl propionate, ethyl propionate, γ-butyrolactone, and the like; ethers such as 1,2-dimethoxyethane, 1,2-diethoxyethane, tetrahydrofuran, 1,2-dioxane, 2-methyltetrahydrofuran, and the like; nitriles such as acetonitrile; and amides such as dimethyl formamide. They may be used singularly or in plural. In particular, the solvent may be a mixed solvent of a cyclic carbonate and a linear carbonate.

The electrolyte may include a gel-type polymer electrolyte prepared by impregnating an electrolyte solution in a polymer electrolyte such as polyethylene oxide, polyacrylonitrile, and the like, or an inorganic solid electrolyte such as LiI and Li₃N, but is not limited thereto.

The lithium salt includes at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₂, LiAlCl₄, LiCl, and LiI.

### MODE FOR INVENTION

The following examples illustrate the present invention in more detail. However, it is understood that the present invention is not limited by these examples.

### Comparative Example 1

Ni_{1/3}Co_{1/3}Mn_{1/3}(OH)₂, a hydroxide composite (with an average particle diameter of 5 μm) was mixed with Li₂Co₃ (with an average particle diameter of 6.5 μm) in a mole ratio of (Ni+Co+Mn):Li of 1:1.03 using a blender. The resulting mixture was pre-fired at 700° C. for 8 hours, slowly cooled, and ground into powder again. The resulting powder was fired at 950° C. for 10 hours, slowly cooled, and ground into powder, preparing a Li(Ni_{1/3}Co_{1/3}Mn_{1/3})O₂ cathode active material.

### Comparative Example 2

Co₃O₄ (with an average particle diameter of 3 μm) and Li₂Co₃ (with an average particle diameter of 6.5 μm) in order to obtain a mole ratio of 1:1.03 between Co and Li, and they were mixed using a blender. The resulting mixture was fired at 950° C. in the air for 12 hours, slowly cooled, and ground again, preparing a LiCoO₂ cathode active material.

### Examples 1 to 8

### Preparation of an Active Material

1) Preparation of a Transition Element Hydroxide Composite

Nickel sulfate, cobalt sulfate, and manganese sulfate were dissolved in distilled water in a composition ratio provided in the following Table 1 in a reactor, preparing a solution including nickel, cobalt, and manganese. Next, 9.5M of sodium hydroxide as a precipitating agent was added to this solution, and ammonium hydroxide as a chelating agent was added thereto in a metal salt/ammonia equivalent ratio of 1, maintaining pH of 11.5. Aprecipitate prepared according to the above procedure was washed and filtrated several times, dried in an oven at a predetermined temperature of 120° C., and ground, preparing a transition element hydroxide composite.

Preparation of an Active Material

The resulting transition element hydroxide composite and Li₂Co₃ (brand name: SQM) were put in a weight ratio of 1.03:1 in a separate container and mixed with a blender. Otherwise, Li₂Co₃ (brand name: SQM), the prepared transition element hydroxide composite, magnesium carbonate, and aluminum hydroxide were put in an appropriate weight ratio acquiring a composition provided in the following Table 1, and then mixed with a blender.

The prepared mixture was pre-fired at 700° C. in the air for 8 hours, slowly cooled, and ground into powder again. The powder was fired at 930° C. in the air for 15 hours, slowly cooled, and ground into powder again, preparing a cathode active material for a lithium secondary battery.

### Example 9

### Preparation of an Active Material

Li₂Co₃ (brand name: SQM) and the transition element hydroxide composite of Example 1 were put in a weight ratio of 1:1.09 in a separate container and mixed with a blender to obtain a powder. The powder was fired at 950° C. in the air for 8 to 9 hours, slowly cooled, and ground again, preparing a cathode active material for a lithium secondary battery.

The active materials according to Examples 1 to 9 and Comparative Examples 1 and 2 had compositions provided in the following Table 1.

*Element analysis (ICP)

TABLE 1

| | Composition |
|---|---|
| Comparative Example 1 | Li(Ni_{1/3}Co_{1/3}Mn_{1/3})O₂ |
| Comparative Example 2 | LiCoO₂ |
| Example 1 | Li_{1.025}Ni_{0.5}Co_{0.2}Mn_{0.3}O₂ |
| Example 2 | Li_{1.021}Ni_{0.54}Co_{0.1}Mn_{0.36}O₂ |
| Example 3 | Li_{1.020}Ni_{0.39}Co_{0.35}Mn_{0.26}O₂ |
| Example 4 | Li_{1.022}Ni_{0.5499}CO_{0.35}Mn_{0.1001}O₂ |
| Example 5 | Li_{1.017}Ni_{0.6003}Co_{0.1}Mn_{0.2997}O₂ |
| Example 6 | LiNi_{0.4896}Co_{0.2}Mn_{0.3008}Al_{0.01}O₂ |
| Example 7 | LiNi_{0.4808}Co_{0.2}Mn_{0.2992}Al_{0.01}Mg_{0.01}O₂ |
| Example 8 | Li_{0.985}Ni_{0.492}Co_{0.15}Mn_{0.358}O₂ |
| Example 9 | Li_{1.0581}Ni_{0.5012}Co_{0.1501}Mn_{0.3487}O₂ |

The Li{Li_{0.025}[Co_{0.2}(Mn_{0.0375}Ni_{0.625})_{0.8}]}O₂ cathode active material for a lithium secondary battery prepared according to Example 1 underwent element analysis (ICP) and as a result, it was found to be Li{Li_{0.021}[Co_{0.21}(Mn_{0.368}Ni_{0.632})_{0.79}]}O₂, which was close to a desired stoichiometric ratio.

Composition Analysis

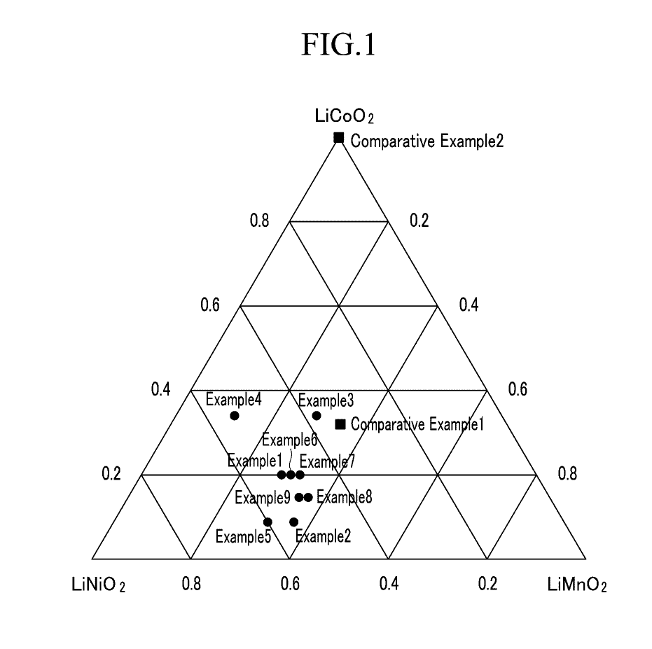

The cathode active materials according to Examples 1 to 9 and Comparative Examples 1 and 2 were measured regarding manganese, cobalt, and nickel composition, and the results are provided in FIG. 1. As shown in FIG. 1, the cathode active material of Comparative Example 1 had almost the same composition of manganese, cobalt, and nickel, but the ones of Examples 1 to 9 included nickel in a higher ratio than the other components, and also had different cobalt and manganese compositions. In addition, the one of Comparative Example 2 included only cobalt.

Property Evaluation

The cathode active materials according to Examples 1 to 9 and Comparative Examples 1 to 2 were evaluated regarding properties, and the results are provided in the following Table 2.

TABLE 2

| | | | | | Specific | |
|---|---|---|---|---|---|---|
| | Secondary particle | | | Tap | surface | Primary particle |
| | D50 | D5 | D95 | density | area | long diameter |
| | (μm) | (μm) | (μm) | [g/cc] | [cm²/g] | size [μm] |
| Comparative | 7.19 | 3.95 | 12.57 | 1.81 | 0.50 | 2.62 |
| Example 1 | | | | | | |
| Comparative | — | — | — | 2.74 | 0.13 | 37.04 |
| Example 2 | | | | | | D₅₀ [μm]: 19.95 |
| | | | | | | D₅ [μm]: 3.95 |
| | | | | | | D₉₅ [μm]: 35.96 |
| Example 1 | 6.09 | 2.87 | 12.76 | 2.00 | 0.51 | 1.18 |
| Example 2 | 5.24 | 3.12 | 9.04 | 1.81 | 0.58 | 1.43 |
| Example 3 | 7.26 | 4.07 | 14.51 | 1.80 | 0.47 | 2.25 |
| Example 4 | 7.67 | 4.06 | 14.01 | 2.10 | 0.48 | 1.24 |
| Example 5 | 7.16 | 3.97 | 13.87 | 2.15 | 0.57 | 1.28 |
| Example 6 | 5.87 | 3.49 | 9.68 | 1.93 | 0.59 | 1.19 |
| Example 7 | 5.74 | 3.21 | 9.83 | 1.97 | 0.61 | 1.21 |
| Example 8 | 5.97 | 3.70 | 10.41 | 1.94 | 0.49 | 0.89 |
| Example 9 | 6.27 | 3.71 | 10.54 | 1.96 | 0.50 | 0.95 |

As shown in Table 2, the cathode active materials according to Comparative Example 1 and Examples 1 to 9 had similar powder characteristic values, but the one of Comparative Example 1 had a particle diameter that was larger than 2.5 μm when primary particles including secondary particles were examined regarding diameter with a scanning electron microscope (SEM). The one of Comparative Example 2 included only primary particles, and the particles had a long diameter of 37 μm or more.

XPS Result

Furthermore, the cathode active materials according to Example 1 and Comparative Example 1 were measured regarding binding energy among Ni, Co, and Mn, using X-ray photoelectron spectroscopy (XPS), and the results are provided in the following Table 3.

TABLE 3

| XPS data | Ni (2p3/2) | |
|---|---|---|
| Comparative Example 1 | 854.55 | Ev |
| Example 1 | 854.65, 856.8 | eV |

When the oxidation state of Ni ions were +2, they had binding energy of 854.5 eV, and when the oxidation state thereof +3, they had binding energy of 857.3 eV.

As shown in Table 3, the cathode active material of Example 1 had binding energy of 854.65, 856.8 eV at a peak of Ni (2p3/2). After the resulting Ni binding energy was shown in a graph, the peaks showing oxidation +2 and +3 were integrated to measure their areas, and then, each of the average oxidation numbers was acquired from a ratio between the area of each oxidation number and the entire area, and as a result, were identified to be +2 and +3. In other words, the cathode active material of Example 1 included Ni with an average oxidation number of more than 2, and precisely, between 2.01 to 2.4. Since the cathode active material of Comparative Example 1 had a Ni (2p3/2) peak of 854.55 eV, the Ni had an oxidation number of 2.

Based on the results in Tables 2 and 3, the cathode active material of Examples 1 to 9 and Comparative Example 1 had different structural properties, which might have an influence on thermal stability.

Thermal Stability Measurement

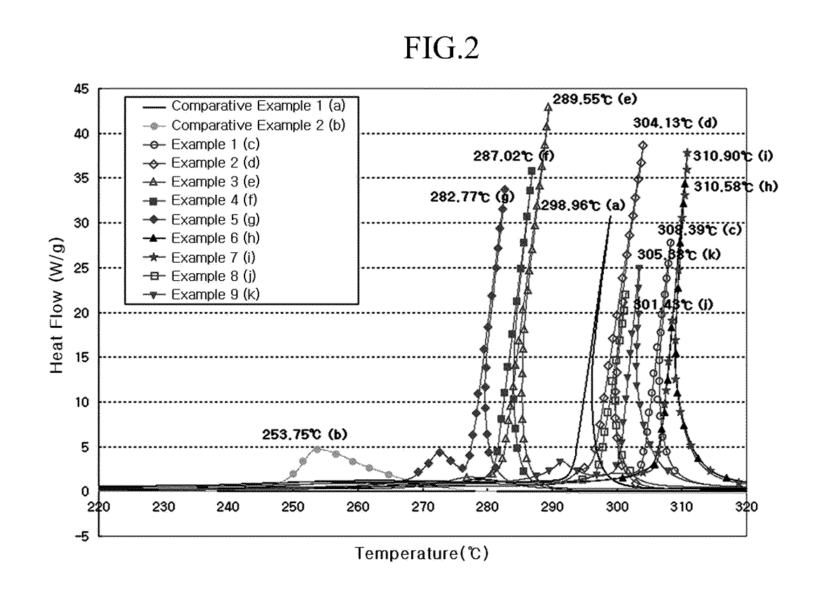

The cathode active materials with a composition (Ni:Co:Mn=5.0:2.0:3.0 mole ratio) of Example 1, a composition (Ni:Co:Mn=5.4:1.0:3.6 mole ratio) of Example 2, a composition (Ni:Co:Mn=3.9:3.5:2.6 mole ratio) of Example 3, a composition (Ni:Co:Mn=5.5:3.5:1.0 mole ratio) of Example 4, a composition (Ni:Co:Mn=6.0:1.0:3.0 mole ratio) of Example 5, a composition (Ni:Co:Mn:Al=4.9:2.0:3.0:0.1 mole ratio) of Example 6, a composition (Ni:Co:Mn:Al:Mg=4.8:2.0:3.0:0.1:0.1 mole ratio) of Example 7, a composition (Ni:Co:Mn=4.9:1.5:3.6 mole ratio) of Example 8, and a composition (Ni:Co:Mn=5.0:1.5:3.5) of Example 9, a composition (Ni:Co:Mn=1.0:1.0:1.0 mole ratio) of Comparative Example 1, and a composition (Li:Co=1.0:1.0 mole ratio) of Comparative Example 2 were measured regarding thermal stability using differential scanning calorimetry (DSC). The results are provided in FIG. 2. As shown in FIG. 2, the cathode active materials according to Examples 1 and 2 and 6 to 9 had higher exothermic temperatures than the one of Comparative Example 1, showing excellent thermal stability. The exothermic temperature indicates a temperature at which a bond between oxygen and a metal is broken and oxygen is decomposed temperature, and the higher exothermic temperature means, the better the stability.

The cathode active materials according to Examples 3 to 5 had lower exothermic temperatures than the one of Comparative Example 1, and somewhat deteriorated thermal stability compared with the one of Comparative

### Example 1

However, the cathode active materials of Examples 3 to 5 had higher exothermic temperatures than the one Comparative Example 2, showing excellent thermal stability compared with the one of Comparative Example 2. As a result, the cathode active materials according to Examples 1 and 2 and 6 to 9 had excellent thermal stability compared to one of Comparative Example 1, and the ones of Examples 3 to 5 had excellent thermal stability compared with the one of Comparative Example 2, which is representatively a commercially-available cathode active material.

SEM Photograph

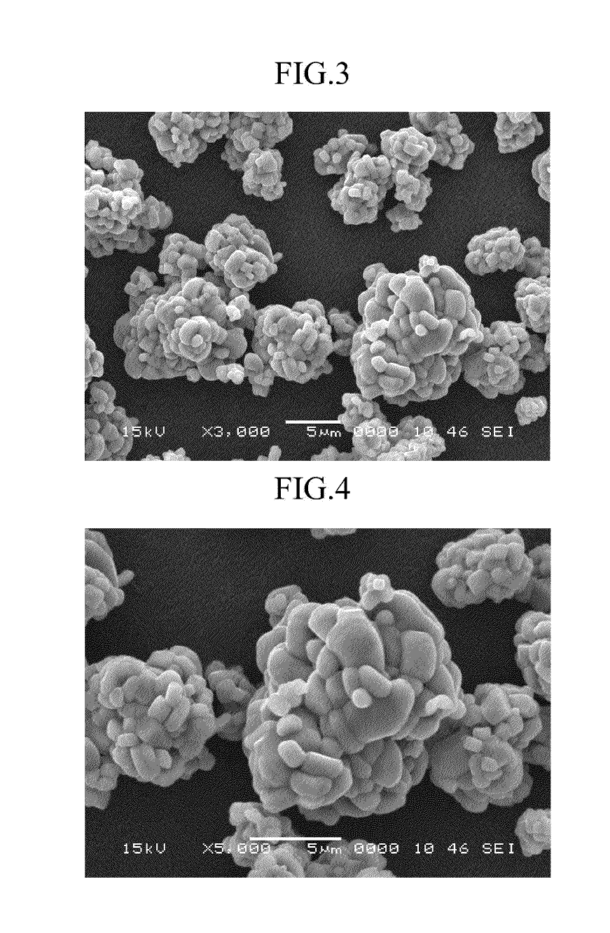

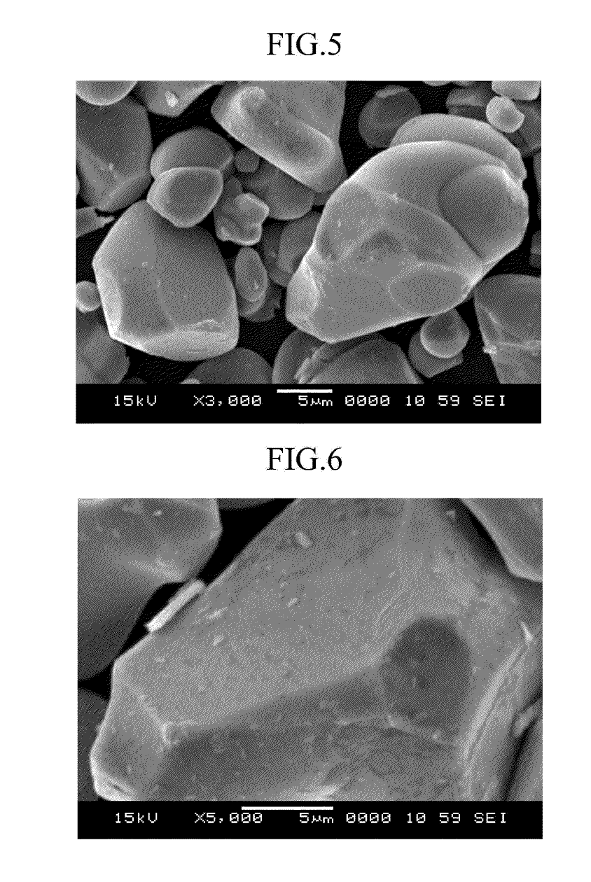

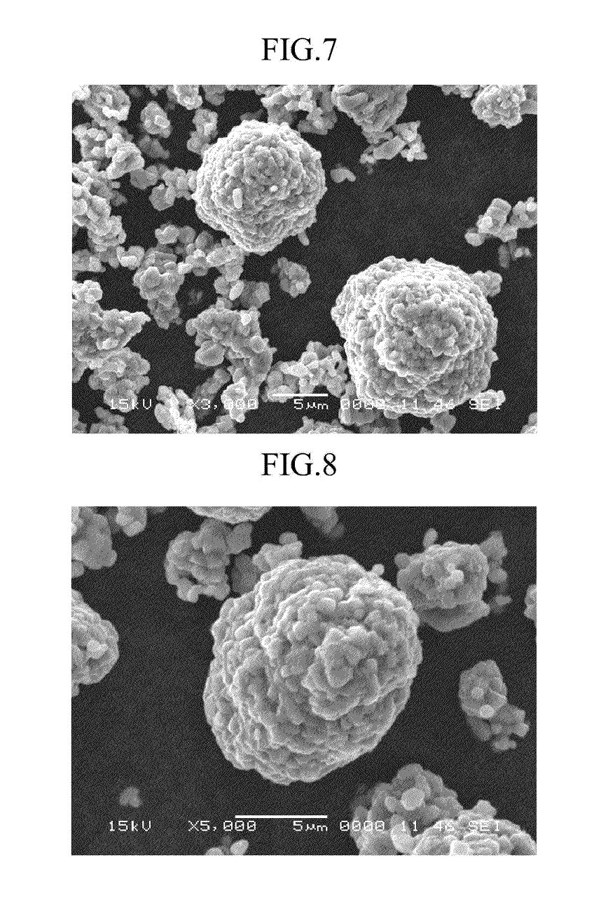

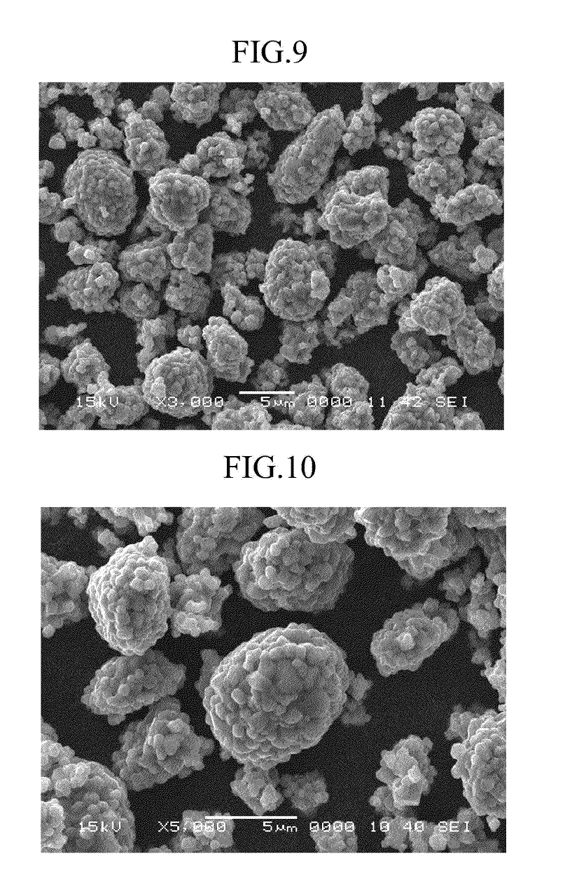

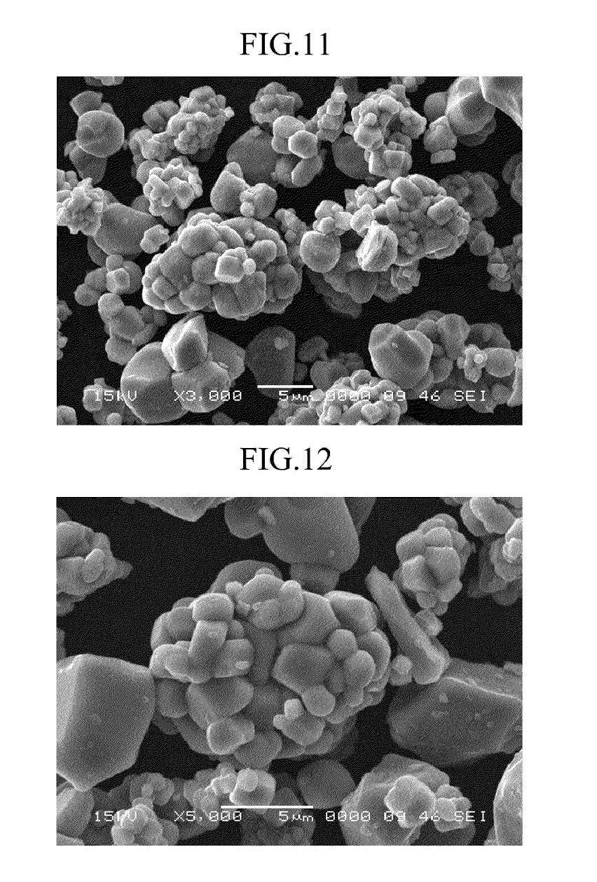

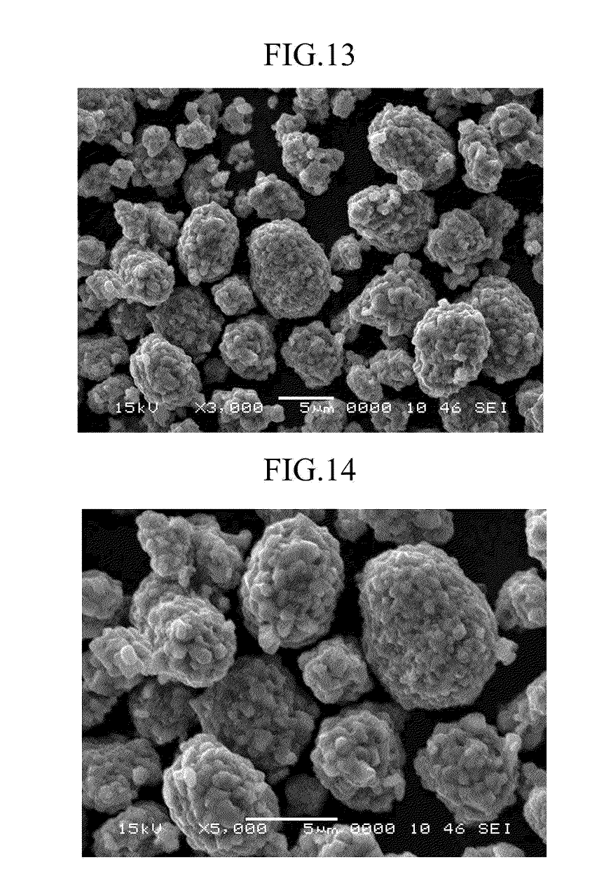

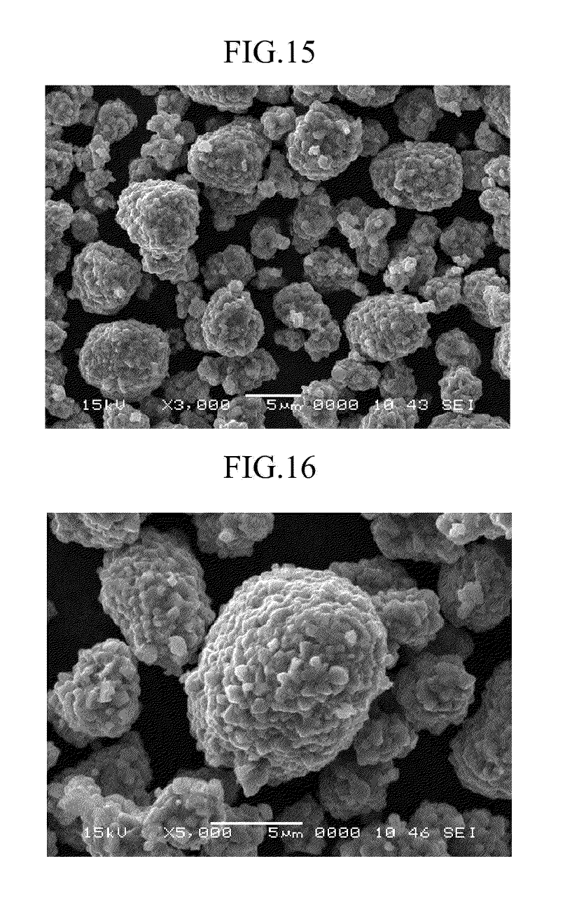

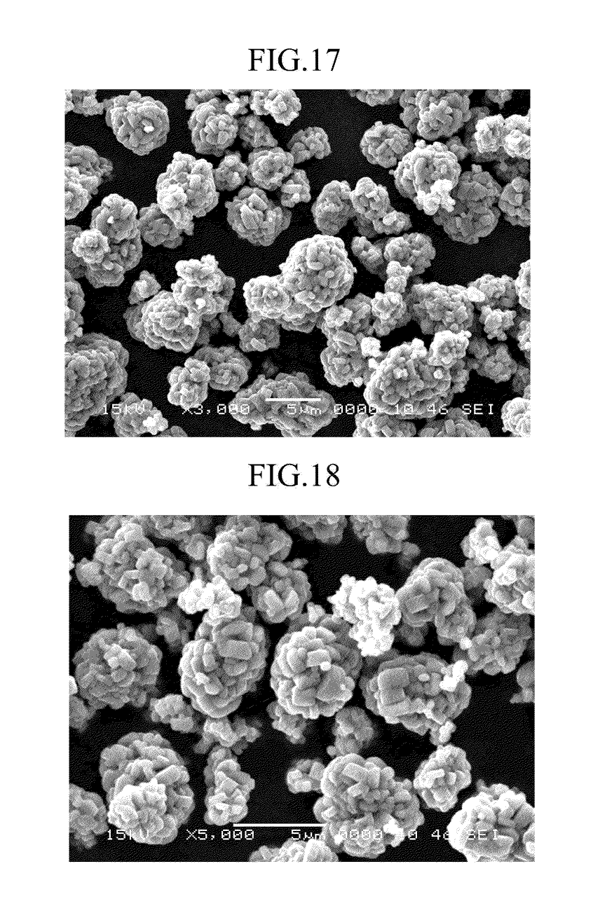

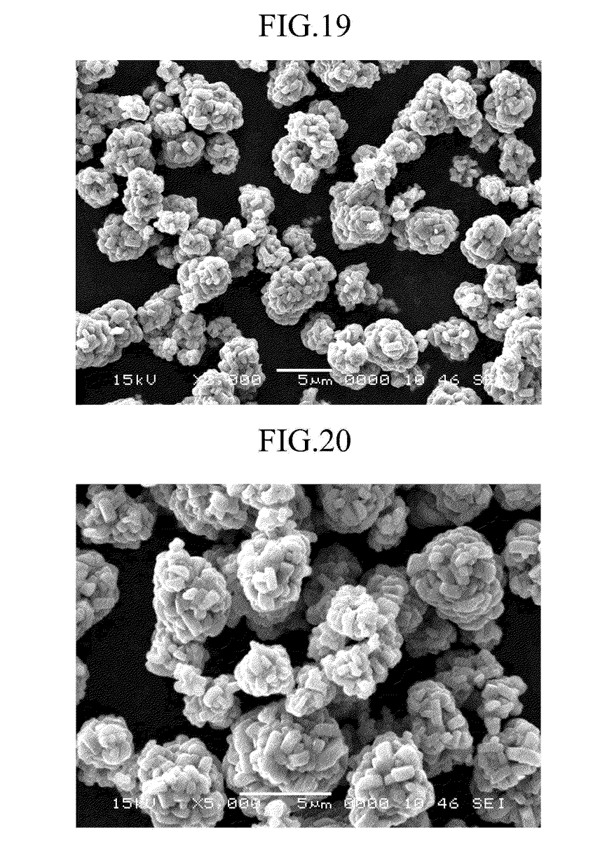

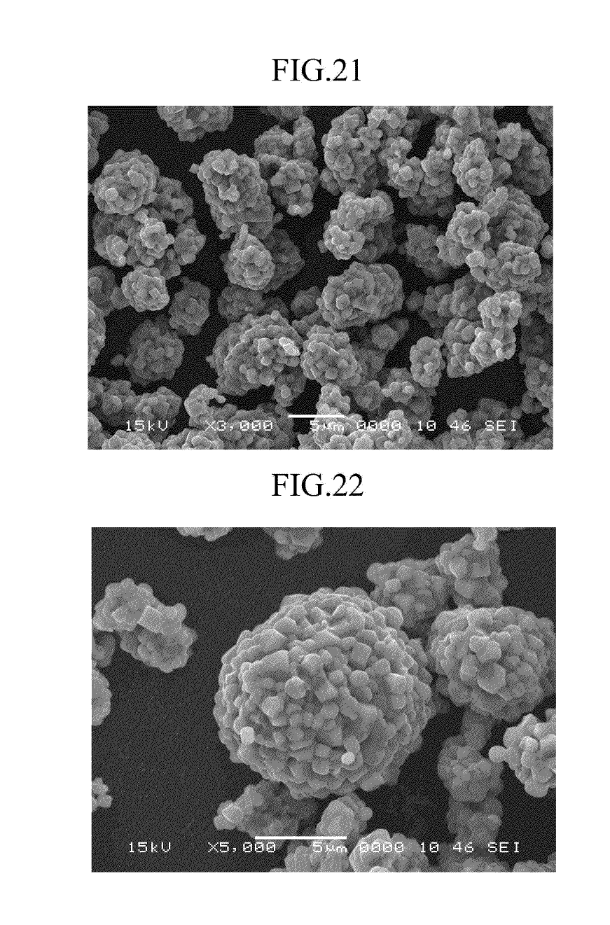

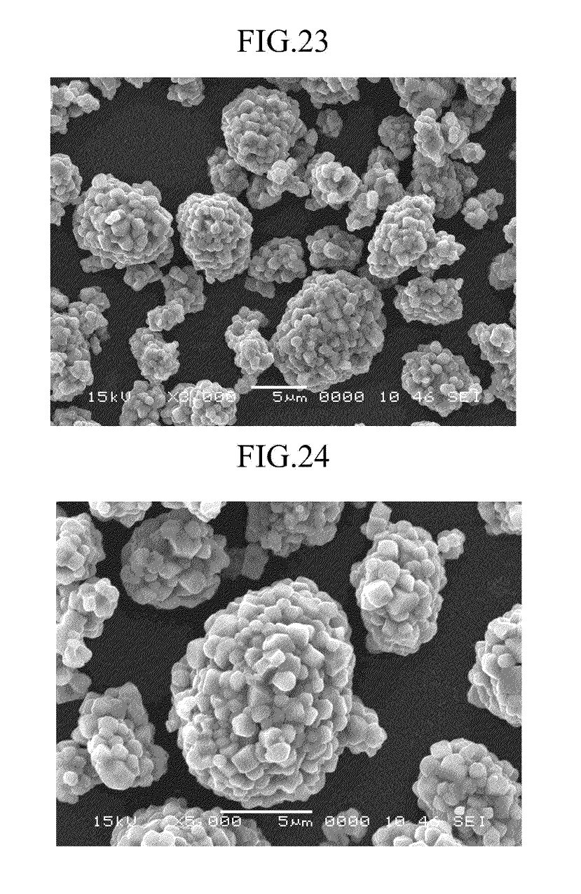

The cathode active material of Comparative Example 1 was photographed at 3000× and 5000× with a scanning electron microscope (SEM), and the results are respectively provided in FIGS. 3 and 4. In addition, the cathode active materials of Comparative Example 2 and Examples 1 to 9 were photographed at 3000× and 5000× with a scanning electron microscope (SEM), and the results are provided in FIGS. 5 and 6 (Comparative Example 2), FIGS. 7 and 8 (Example 1), FIGS. 9 and 10 (Example 2), FIGS. 11 and 12 (Example 3), FIGS. 13 and 14 (Example 4), FIGS. 15 and 16 (Example 5), FIGS. 17 and 18 (Example 6), FIGS. 19 and 20 (Example 7), FIGS. 21 and 22 (Example 8), and FIGS. 23 and 24 (Example 9). As shown in FIGS. 3, 4, 7 to 10, and 13 to 24, excluding FIGS. 11 and 12, the cathode active materials of Examples 1, 2, and 4 to 9 had secondary particles assembled with finer primary particulates than the one of Comparative Example 1. In addition, as shown in FIGS. 11 and 12, the cathode active material of Example 3 had secondary particles assembled by primary particulates with a similar size to Comparative Example 1.

In this way, the cathode active materials of Example 1 to 9 included fine primary particles with an average long particle diameter ranging from 0.5 to 2 μm, improved ion conductivity, and excellent electrochemical and long cycle life (degradation of discharge characteristic as the cycle number increases) characteristics at a high rate, thermal stability, and the like, and accordingly, it may be appropriately used as a cathode active material for a lithium secondary battery, particularly under extreme conditions. In addition, since the primary particle has a smaller average particle diameter, it may increase the bulk density by press molding when it is fabricated into a cathode, improving capacity of a battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A cathode active material for a lithium secondary battery, comprising a lithium composite oxide represented by the following Chemical Formula 1:
Li[Li_{z}A]O₂
A={M¹_{1-x-y}(M¹_{0.78}Mn_{0.22})ₓ}M²_{y} [Chemical Formula 1]
wherein, M¹ and M² are independently one or more selected from a transition element, a rare earth element, or a combination thereof, and M¹ and M² are elements that are different from each other, and −0.05≦z≦0.1, 0.8≦x+y≦1.8, 0.05≦y≦0.35, and Ni has an oxidation number of 2.01 to 2.4.

2. The cathode active material of claim 1, wherein the z, x, and y are in the following ranges of −0.03≦z≦0.09, 1.0≦x+y≦1.8, and 0.05≦y≦0.35.

3. The cathode active material of claim 1, wherein M¹ is selected from the group consisting of Ni, Co, Ti, Mg, Cu, Zn, Fe, Al, La, Ce, and a combination thereof, and
M² is selected from the group consisting of Ni, Co, Ti, Mg, Cu, Zn, Fe, Al, La, Ce, and a combination thereof.

4. The cathode active material of claim 2, wherein M¹ is Ni and M² is Co.

5. The cathode active material of claim 1, wherein the lithium composite oxide is a secondary particle assembled by primary particles, and the secondary particle is spherical.

6. The cathode active material of claim 5, wherein the primary particle has an average long particle diameter ranging from 50 nm to 2.5 μm.

7. The cathode active material of claim 6, wherein the primary particle has an average long particle diameter ranging from 200 nm to 2.3 μm.

8. A lithium secondary battery comprising:
a cathode comprising a lithium composite oxide represented by the following Chemical Formula 1 cathode active material;
an anode comprising an anode active material; and
an electrolyte:
Li[Li_{z}A]O₂
A={M¹_{1-x-y}(M¹_{0.78}Mn_{0.22})ₓ}M²_{y} [Chemical Formula 1]
wherein, M¹ and M² are independently one or more selected from a transition element, a rare earth element, or a combination thereof, M1 and M2 are elements that are different from each other, −0.05≦z≦0.1, 0.8≦x+y≦1.8, and 0.05≦y≦0.35, and Ni has an oxidation number of 2.01 to 2.4, −0.05≦z≦0.1, 0.8≦x+y≦1.8, 0.05≦y≦0.35, and Ni has an oxidation number of 2.01 to 2.4.

9. The lithium secondary battery of claim 8, wherein the z, x, and y are in the following ranges of −0.03≦z≦0.09, 1.0≦x+y≦1.8, and 0.05≦y≦0.35.

10. The lithium secondary battery of claim 8, wherein M¹ is selected from the group consisting of Ni, Co, Ti, Mg, Cu, Zn, Fe, Al, La, Ce, and a combination thereof, and
M² is selected from the group consisting of Ni, Co, Ti, Mg, Cu, Zn, Fe, Al, La, Ce, and a combination thereof.

11. The lithium secondary battery of claim 8, wherein M¹ is Ni and M² is Co.

12. The lithium secondary battery of claim 8, wherein the lithium composite oxide is a secondary particle assembled by primary particles and is spherical.

13. The lithium secondary battery of claim 8, wherein the primary particle has an average long particle diameter ranging from 50 nm to 2.5 μm.

14. The lithium secondary battery of claim 13, wherein the primary particle has an average long particle diameter ranging from 200 nm to 2.3 μm.
